(19) United States
(12) Patent Application Publication
(10) Pub. No.: US 2017/0042124 A1
(43) Pub. Date: Feb. 16, 2017

(54) Modular Low-Tangling Shock-Absorbant Dog Leash System

(71) Applicants: Richard T. Cooper, Oceanside, CA (US); John M. Johnson, III, Redlands, CA (US)

(72) Inventors: Richard T. Cooper, Oceanside, CA (US); John M. Johnson, III, Redlands, CA (US)

(73) Assignee: uLeash, LLC., Oceanside, CA (US)

(21) Appl. No.: 15/079,838

(22) Filed: Mar. 24, 2016

Related U.S. Application Data
(63) Continuation-in-part of application No. 62/204,984, filed on Aug. 14, 2015.

(51) Int. Cl. A01K 27/00

(52) U.S. Cl. CPC A01K 27/005; A01K 27/003

(57) ABSTRACT

A dog leash with low-tangling and shock-absorbent properties comprises a handle, a wrist guard, a body, and a chew guard with an attachment. The segments are connected with interchangeable swivel connectors.

### RELATED APPLICATIONS

This application is a Continuation-In-Part of U.S. Provisional Application 62/138,806, filed 26 Mar. 2015; and 62/204,984, filed 14 Aug. 2015. Both applications are incorporated herein by reference, as if set forth in full.

### FIELD OF THE INVENTION

This invention relates to leashes, tethers or leads for animals, more particularly dog leashes that have increased convenience and utility, and which facilitate compliance with state laws and municipal ordinances. A padded handle patterned after a surf leash, originally designed to fasten the wrist or ankle of a surfer to a surfboard, is combined with a wrist guard, a leash body, and a chew guard having a collar or harness fastener. In an alternative embodiment, a handle patterned after a luggage handle, with an added quick-connect buckle, is combined with an extension, wrist guard, body, and chew guard with collar or harness fastener. The various modules of the pet leash are joined by swivel connectors. The resulting combination is surprisingly shock-absorbent, non-binding, and nearly tangle-free. It is preferably resistant to water and salt exposure. Further, the padded handle is easily attached to a seat belt or safety harness, to easily, quickly, and more safely secure an animal during transport required by California law. Where the fittings in the swivel connectors are identical, the various portions of the leash may be made of a wide variety of lengths, materials, colors and strengths, yet any premade component can be joined to any other premade component.

### BACKGROUND OF THE INVENTION

Pet leashes, particularly dog leashes, are a necessity in many modern urbanized areas, both for the purposes of controlling and protecting the animal, and sometimes to comply with local law. At its simplest, a leash may be, for example, an elongated piece of web with a loop at one end and a fastener on the other. However, the needs and variety of dogs, as well as their owners, have led many to improve on this design. Leashes are also used for a variety of other purposes, including water sports.

U.S. Pat. No. 8,327,808 issued to Chirico Dec. 11, 2012, relates to a universal dog leash made of stretchable, resilient material having identical halves, each half having a fixed circular ring with a snap attached to each end.

U.S. Pat. No. 7,708,612 issued to Wardle May 4, 2010, relates to a leash and information system assembly for a water sport vehicle. The leash is used to tether surfboards, boogie boards, and sail boards to a user's wrist or ankle, by means of a flexible strap and a tether cord. The patent discloses that the strap, cord or vehicle may further comprise an information system, which includes a data processing module and a display module.

U.S. Pat. No. 6,626,132 issued to Mann on Sep. 30, 2003, discloses and claims a multiple pet leash that relies on the use of “D” rings.

U.S. Pat. No. 4,041,562 issued to Nealy Aug. 16, 1977, relates to a surfboard leash that includes an ankle attachment including a flexible strap and a quick release Velcro™ fastener, and a flexible, resilient cord which is said to reduce shock on the ankle of the surfer. The resilient cord is attached to the strap by means of a buckle having a boss with a passage, so that the resilient cord extends into the passage and is prevented from withdrawing through the passage. This reference also discloses connectors that are rigid hooks with movable resilient arms that allow rotation of the resilient cord as by swivel (Col. 3, lines 5-10).

U.S. Pat. No. 6,192,835 issued to Calhoun et al. on Feb. 27, 2001, discloses a hands-free pet leash system, where the handle of a leash wraps around the belt, and has at least two quick-connect features. Both features are disclosed to comprise a buckle connector (female portion) and a pronged connector (male portion).

U.S. published application Ser. No. 13/418,513 filed Mar. 13, 2012, by Capoano, discloses a waist-belt including at least one embedded, retractably controllable pet leash.

U.S. Pat. No. 8,622,028, issued to Ekstrum Jan. 7, 2014, relates to a belt with a D-ring that slides freely around the belt.

U.S. Pat. No. 7,467,604, issued to Wermer, et al on Dec. 23, 2008, relates to a pulley which rides on a flexible waist cord which in turn is attached by swivels to a waist belt to permit the dog to move side to side without unbalancing the person.

U.S. Pat. No. 5,950,569, issued to Perrulli Sep. 14, 1999, relates to a belt having a slider and a coupler that can be attached to a lead. U.S. Pat. No. 5,429,075, issued to Passarella, et al., Jul. 4, 1995, relates to a pet leash with a holder for a flashlight attached near the handle.

United States Patent publication US 20040112303 A1 by Moulton, III dated Jun. 17, 2004, relates to an extension leash with a coupler having a rotating mount that may be attached to a wearer's belt.

A variety of leash lines and systems are commercially available. For example, Tuenne of Santa Monica, Calif. sells products at http://tuenne.com/products/detail/Mammoth_Leash/. It is disclosed that all of Tuenne's leashes come with locking carabiners, an item not necessary to the present inventions.

EZyDog LLC., of Ponderay, Idaho, discloses a wide variety of dog leashes and accessories, including a Double Dog solution and a shock absorbing Dog Leash, as well as car restraints, all available at store.ezydog.com.

Rruffwear, Inc. of Bend, Oreg. advertises canine outdoor gear at ruffwear.com.

Tug-No-More, LLC., of Grosse Point, Mich., has a website at tugnomore.com which features a harness that fits around the user's hips to allow hands-free use of a leash.

Liberty Wristbands, found at www.libertywristband.com, discloses a Liberty Wristband Leash Holder available for order that appears to be a neoprene pad with a Velcro™ closure and a quick-release metal clasp. https://www.indiegogo.com/projects/revolutionary-device-changes-face-of-dog-walking-2#/story.

Surfdog Australia shows a leash at http://www surfdogaustralia.com/collections/collar-and-leashsets/products/radical-beach-leash having wide comfort neoprene padded handle, a urethane cord, and short piece of webbing attached to a shackle.

US Patent publication No. 20100024741 A1 by Robert Paul Schoppman, published Feb. 4, 2010, re “Buddy Leash System describes a customizable tripart leash system (handle, leash, collar connector) with buckle quick connects attached to nylon webbing the same width as the buckles and the option to add other features, including a leash extension, and options to hang various items (bags for keys, animal waste, leash extension) on the leash.

In addition to the concerns of an ordinary owner, California Vehicle Code §23117 requires any animal transported in the back of a vehicle “in a space intended for any load” on the highways be either (1) cross tethered to the vehicle or protected by a secured container or cage . . . .” Although this section reads directly on the open back of a truck, the language is broad enough to arguably cover the back seat of a car. In any case, the animal should be secured in a moving vehicle, in the event of an accident.

There is therefore a felt need for a dog leash that is comfortable for both the dog and the dog handler, and also durable, resilient, and configurable to the convenience of a wide variety of handlers and dogs.

The inventors have previously produced and marketed a leash that may have one of two handles, namely a modified soft padded grip with a Velcro™ hook and loop closure and a modified flexible rubber luggage grip with a quick-connect buckle, a body of urethane cord, and a 6 to 8 inch woven strap intended to serve only as a connector between the body and a shank or clip to attach to an animal's harness. The handle and body were connected with a swivel connector. The inventors have lengthened the connector to acquire an additional function, that of a chew guard. The inventions described herein are an improvement over the inventors' own product. In addition the inventors have added a wrist guard, or an extension plus wrist guard to the leash, to further improve its functionality.

### BRIEF SUMMARY OF THE INVENTION

The present invention relates to an improved animal leash that is convenient, easy to assemble, easy to use, tangle resistant and shock absorbing. An advantage of this leash is that it has a handle that includes a primary grip that is easy to grasp, and is easily opened and re-fastened. Another advantage is that it has a wrist guard that is easily grasped and which protects the hand and wrist of the user. The wrist guard also serves as a secondary grip, for improved control of the animal. Another advantage is that the body of the leash can be chosen to be strong, resilient, shock-absorbing and aesthetically pleasing. Yet another advantage is that it has a chew guard, which is sturdy and allows the dog some option to grab and hold the leash without damaging the leash or being harmed. The chew guard attaches to the animal's collar or harness, and can be configured to have a Velcro™ hook-and-loop fastener, to easily remove and replace a metal shackle, or may be used without a shackle. Without the shackle, the leash is softer and lighter. Finally the leash as a whole is appealing in appearance, fully customizable, easy to repair, easily cleaned and comfortable to use.

The advantages of this invention are obtained by a modular system whereby the handle, wrist guard, body, and chew guard are produced as separate subunits operably connected by interchangeable swivel connectors, so that each portion of the leash is separately optimized for its functions. A further advantage of the modular system is that a leash can be assembled in the presence of the customer and the animal, thereby maximizing customer satisfaction and also maximizing efficiency of use of the component parts to make a wide variety of individual products. Where multiple couplers are used, a leash can potentially accommodate any number of animals. The low-tangling feature of the leash makes it practicable to manage the animals.

A swivel connector can be quickly and easily configured as a safety release by using a cotter pin or push-pull pin in place of the hex head screw to fasten the swivel to a module. Further, because each module is somewhat separated from the others, the modules have a small amount of independent motion. As a result, when one of the ends of the invention is pulled sharply, some of the force is dispersed, hence an additional shock absorption effect. As the needs of the dog or owner change, any of the modules can be replaced easily, for example due to growth of the dog or damage to any piece.

Yet another advantage of the present invention is that it readily supplies different types of handles for different users and purposes. The handle has a comfortable hand grip, a temporary quick tether, and an attachment for a connector. A firm grip, such as an ergonomic rubber, thermoplastic or leather handle, has the advantage of enhancing control of an animal for training or during work. A soft and padded handle is advantageous for use by a person with a loose or weak grip. In each case, the temporary quick tether allows the handle to be threaded through a user's belt loop for hands-free use, or to secure the animal quickly to another object. Because of the quick-release feature, the leash handle can be adapted to connect multiple dog leashes of any variety together. The attachment for a connector can be any type suitable to secure a connector. The attachment preferably is suitable to secure a connector that is interchangeable with another handle an/or the other segments of the leash, especially the wrist guard or body, so that the handles can be readily changed to suit the user or the circumstances.

### BRIEF DESCRIPTION OF THE DRAWINGS

FIG. 1. Two views of a single embodiment of the handle of the prior art of the inventors.

FIG. 2. Top view of the fully assembled preferred medical leash embodiment of the invention.

FIG. 3. Top view of the fully assembled preferred tactical leash embodiment of the invention.

FIG. 4. Top view of a splitter having two terminal ends.

FIG. 5. Top view of a splitter having three terminal ends.

FIG. 6. Open and closed side views of an adaptor accessory.

### DETAILED DESCRIPTION OF THE DRAWINGS

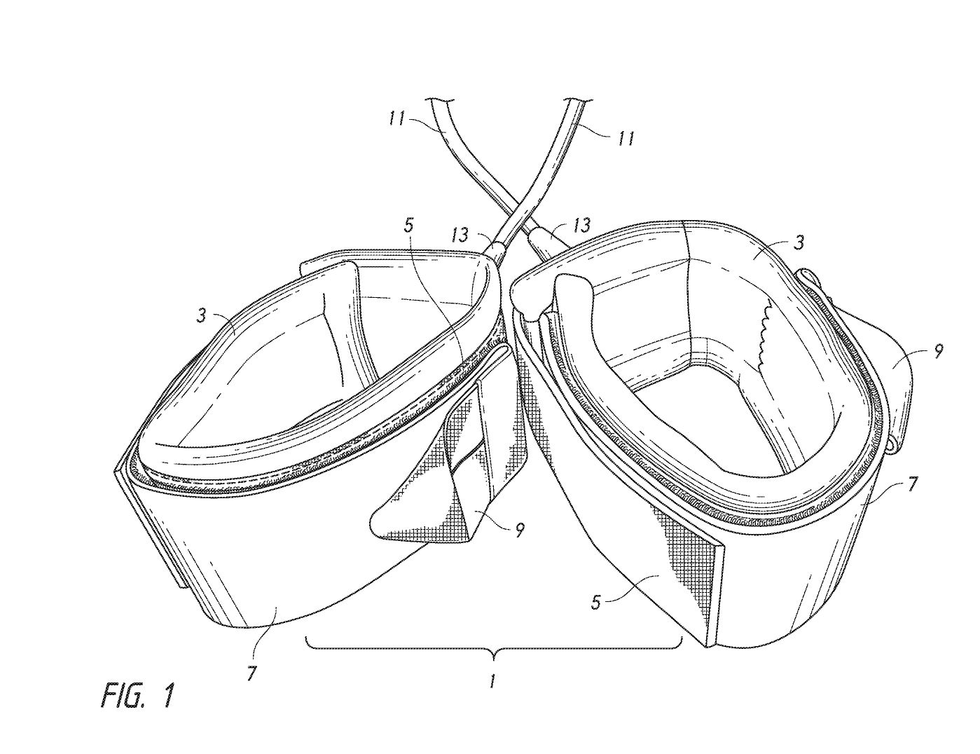

In FIG. 1. Two handles (1) of similar construction are shown, each having a padded strap (3) reinforced with a strip of polypropylene web (5) fitted with a hook and loop closure (7) terminated with a loop (9). Attached to each handle is a body (11) with an endcap (13). A male/male swivel fitting (not shown) joins the endcap (13) and handle (1).

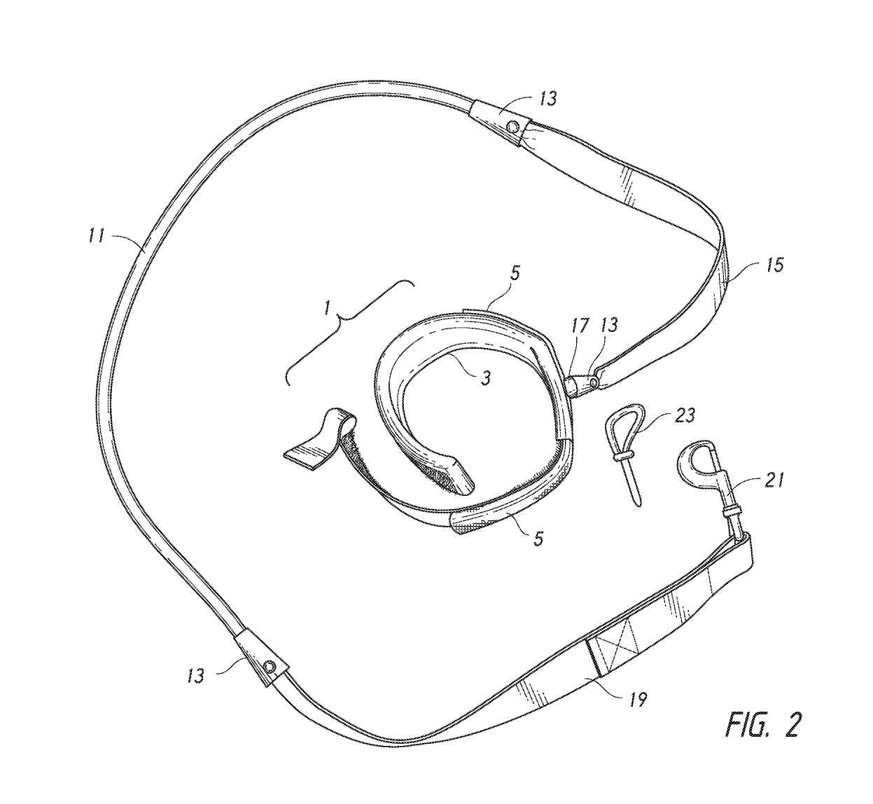

In FIG. 2, The medical leash comprises the handle (1) having a padded strap (3) reinforced with a strip of polypropylene web (5) connected to the wrist guard (15) by means of a swivel mount (17) operatively connected to a swivel fitting (not shown) operably connected to endcap (13). Wrist guard (15) terminates with a swivel fitting (not shown) operably attached to an endcap (13) portion of a body (11). Body (11) terminates with an endcap (13) operably connected to a swivel fitting (not shown) attached to a chew guard (19) which terminates in a shackle (21). A hex head screwdriver such as a surf key (23) is conveniently used to attach and separate parts joined by the swivel fittings.

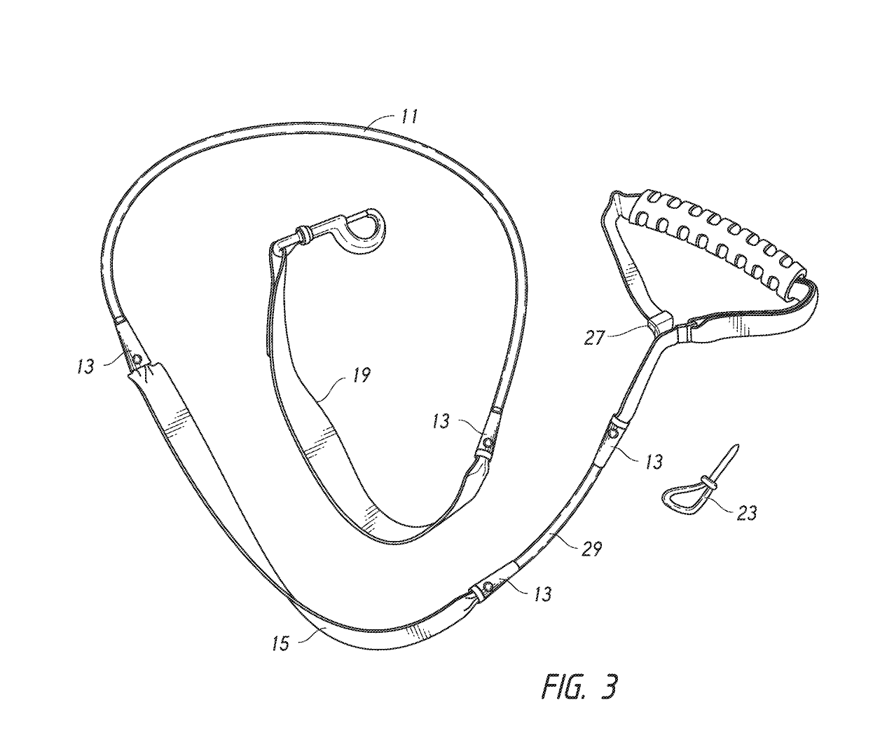

In FIG. 3, the tactical leash comprises a repurposed luggage handle (25) having a buckle (27) and a swivel fitting (not shown) operatively connected to an endcap (13) of an extension (29) with a second endcap (13) operatively connected to a swivel fitting (not shown) attached to a wrist guard (15) that terminates with a swivel fitting (not shown) operatively attached to an endcap (13) of body (11). Body (11) terminates with an endcap (13) operatively connected to a swivel fitting (not shown), attached to a chew guard (19) that terminates in a shackle (21). Again, surf key (23) is conveniently used to attach and separate parts joined by the swivel fittings.

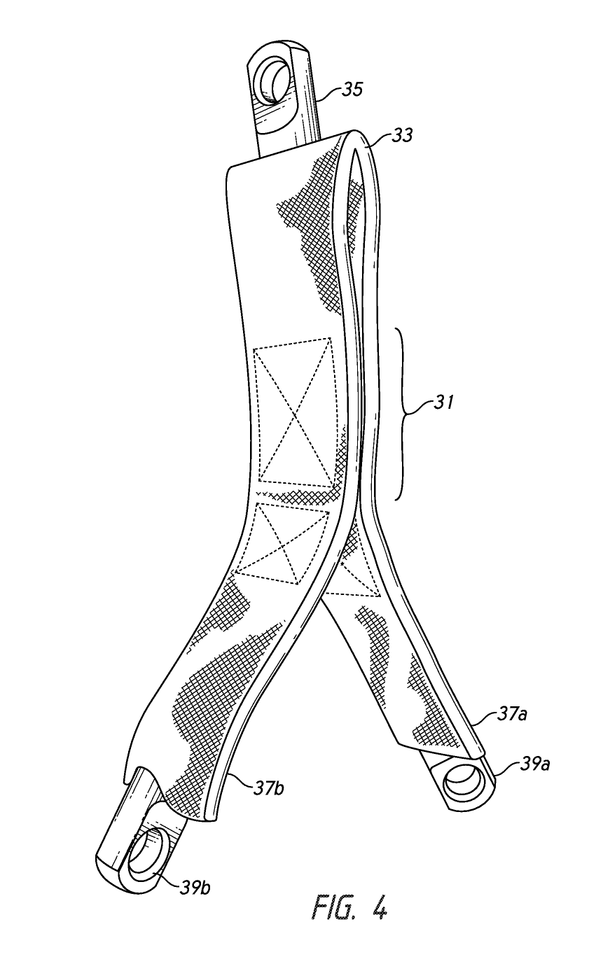

In FIG. 4, Splitter (31) has a first terminal end (33) with an attached first swivel connector (35) that is adapted to connect to the handle, extender, or body segment of the leash (not shown), and two second terminal ends (37a,b) each with an attached second swivel connector (39 a,b). The second swivel connectors (39 a,b) fasten to body segments (not shown).

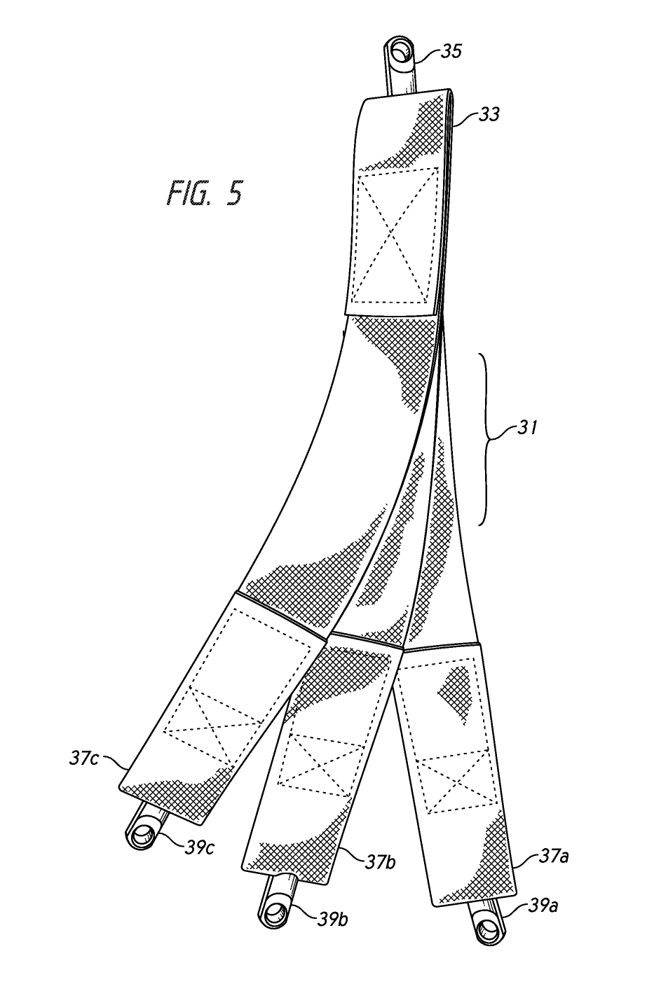

In FIG. 5, Splitter (31) has a first terminal end (33) with an attached first swivel connector (35) that is adapted to connect to the handle, extender, or body segment of the leash (not shown), and three second terminal ends (37a,b,c) each with an attached second swivel connector (39 a,b,c). The second swivel connectors (39 a,b,c) fasten to body segments (not shown).

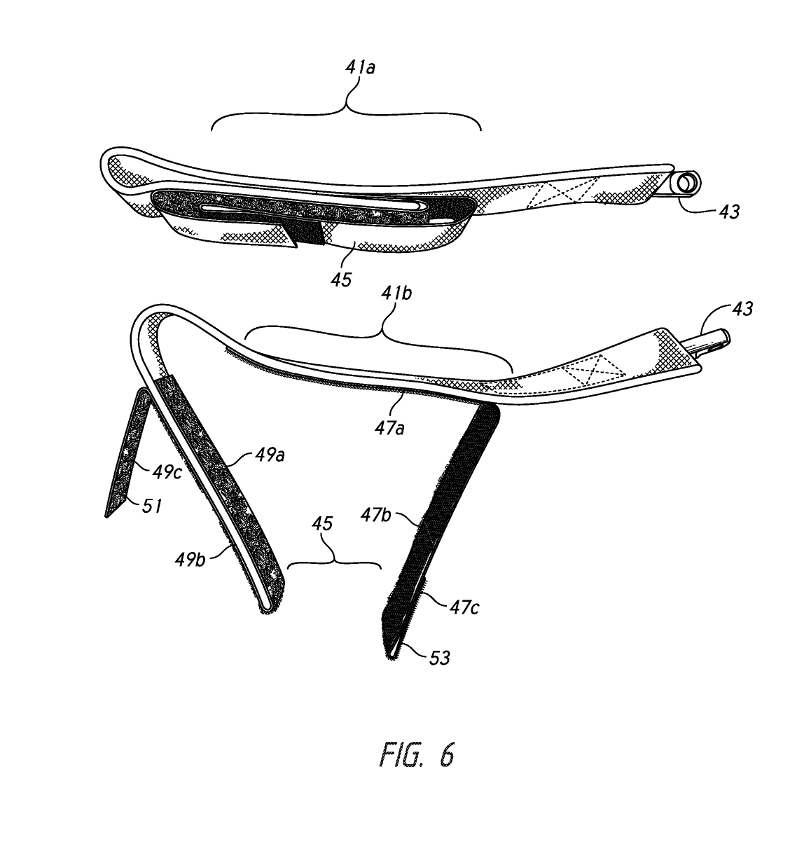

In FIG. 6, adaptor acccessory (41a,b) is shown in both closed (41a) and open (41b) positions. Adaptor accessory (41a,b) has a first swivel connector (43) that is adapted to connect to the body of the leash (not shown), and a second connector, a Velcro™ hook and loop closure (45). A layer having a hook surface (47) is adapted to mate with loop surface (49). Hook surface section (47a) mates with loop section (49a), hook surface section (47b) mates with loop section (49b). For extra security, a locking tab 51 is provided, where hook surface section (49c) mates with an extension (53) of hook surface (47c).

### DETAILED DESCRIPTION OF THE INVENTION

In a preferred embodiment, the leash is a medical leash, adapted for use by persons who are frail or have difficulty closing and gripping with their hands. The handle may have a grip that is a padded strap reinforced with a strip of polypropylene web. The temporary quick tether is a Velcro™ hook and loop closure. The Velcro™ hook and loop closure preferably terminates with a handle or loop, to facilitate quick opening. The attachment for the connector is preferably a swivel mount with a stitchable plate and fitting holder, preferably made of polyurethane plastic, adapted to secure a swivel fitting. The preferred swivel fittings are male/male swivel connectors which have a threaded aperture for receiving a hex screw. The hex screw is preferably stainless steel. The screws can be conveniently manipulated by means of a screwdriver such as an allen wrench, drill bit, or surf key.

Suitable handles of this embodiment are patterned after a surf leash. The padded strap may be reinforced with a strip of web made of any suitable fabric such as nylon, polyester, polyurethane, or the preferred polypropylene. Straps are made of softly padded polypropylene knit material, but can be made of any suitable synthetic or natural material and color, including nylon, polyester, polyurethane silk, cotton, neoprene and leather. The strap is typically between 2 and a half inches to about half an inch width, preferably about 2, 1, or ½ inch, but can be wider or narrower as desired. In particular, a width of one inch may be favored by humans with smaller hands. Taken as a whole, the handle is soft and resilient, minimizing the possibility of accidental damage to the owner and the pet. Because the handle can be easily opened, the leash has the added advantage of being adaptable to hands-free use, and also to secure an animal for transport.

It is an aspect of the present invention that the handle of the presently described medical leash, absent the swivel mount or with it, is suitable for use as a quick attachment to a safety harness, seat belt or other anchor, for use in motor vehicles. This handle has the particular advantage of having soft padding and minimal hard parts, thereby minimizing harm in the event of an accident. The handle may be held in the hand, or the user may put a hand through it and grasp the wrist guard.

In addition, the medical leash has a wrist guard, which is typically a strip of polypropylene web 10 to 18 inches long, and preferably about a foot long, with identical swivel fittings secured at each end. At present, the wrist guards are custom made by or on behalf of the inventors. The swivel fittings are preferably sewn to the wrist guard, but can be mounted in any suitable fashion, including the use of a mount, endcap, glue, or some combination thereof. The wrist guard is preferably attached to the handle through its first swivel connector, and protects the hands and wrist of the user in the event of a sudden pull or tug on the handle, where the leash may lay across the user's hand. In addition, the wrist guard is easily grabbed and comfortably held by the hand. The wrist guard may be made of any suitable material, such as polypropylene, nylon, polyester or polyurethane web, or leather, and is conveniently about an inch wide. Further, the wrist guard may be constructed with an additional graspable feature such as a loop to facilitate shortening and control of the leash, particularly to close the gap between the handler and the animal. The second swivel connector of the wrist guard attaches to the body of the leash.

The swivel connectors may be any type of swivel connector of suitable strength and corrosion resistance. Swivel connectors using low-rust male-male brass or nickel-coated brass fittings are preferred. The fittings are adapted to receive a screw with a hex head, preferably made of stainless steel. These fittings can be conveniently used to join the component parts of the leash using a drill bit, allen wrench or surfboard key. For further convenience, all of the swivel fittings used in the leash are interchangeable. Furthermore, one or more of the swivel fittings may be configured as a safety release by use of a cotter pin or a push-pull pin in lieu of the more typical screw.

The body of the medical leash corresponds to the major portion of a prior art leash, and may be made of any of the materials from which leashes are made. For the purposes of the medical embodiment, resilient, shock absorbing, non-tangling materials are preferred. These include various types of web, rope or strap, chains, preferably with a cover or sleeve, which may be transparent or decorative, leather, urethane tubing or cord, and clear tubing filled with a colored, phosphorescent or fluorescent material. Most preferred is an extruded urethane rod or cord having a hardness rating of 88-90 as a durometer reading. Such cords may be of variable diameter, typically between 0.220-0.390 inches. Such cords are currently custom-made on behalf of the inventors. The inventors bond and glue an endcap with a female plug adapted to receive a male/male double-ended swivel connector to each end.

The chew or bite guard is a modification of a short piece of web that originally served as a connector between the body of the leash and a shackle or clip to connect to the dog's collar or harness. It can be made of any suitable material, such as the materials suitable for a wrist guard, and is more preferably polypropylene web with doubled-up and extra stitches. This piece was originally about 6 inches, but has been modified to 10 to 18 inches, preferably 12 to 13 inches or so in length. The change in length allows the dog to take the guard in its mouth, without damage to either dog or leash. Where communication between dog and human is good, this feature allows additional recoil, particularly at the beginning of a walk. If the dog is holding the chew guard when the human first pulls on the leash, the dog's head turns slightly which absorbs some shock and avoids an uncomfortable snap in the leash.

The chew guard preferably has a first swivel connector that is adapted to connect to the body of the leash, and a second connector, which may be a swivel connector, but is preferably shackle, clip, or Velcro™ hook and loop closure. The second connector fastens to an animal's collar or harness. An advantage of the hook and loop closure is that no metal or hard plastic is involved, so that all parts of the chew guard are soft and minimally damaging. In addition, the preferred body of the leash (urethane cord) is not inviting for the dog to grab or chew. A dog might grab the connector between the body and the chew guard, but typically will prefer to grab the chew guard, which is preferably made of webbing and therefore more comfortable and more likely to retain the dog's scent.

For ease of use and reconfiguration of the medical leash, the swivel fittings that connect the handle, wrist guard, leash body and chew guard are preferably interchangeable, thereby maximizing the adaptability of the leash.

The medical embodiment of the leash minimizes hard and potentially injurious pieces, minimizes tangling and maximizes shock absorbance and comfort for both the user and the dog.

Another preferred embodiment includes a belt or shoulder harness for hands-free use. The belt preferably comprises an inner surface that is comfortable for the wearer, such as a padded strap, a reinforcing strip of polypropylene web, and a quick-release buckle, or hook-and loop fastener. The belt can be made of any of the materials similar to the handle of the medical leash. A urethane cord is typically anchored or stitched to the polypropylene web at intervals so that the handle of a leash may be easily and slidably attached to the belt.

Where such a belt is used, a safety release is preferably incorporated into the belt or leash. Such a safety release can be a cotter pin or push-pull pin adapted to attach to the swivel fitting connecting the body of the leash to its handle, in place of the previously discussed hex head screw.

The user may then attach the belt around the waist or around the shoulder and arm, and then fasten the buckle and adjust the length. The handle of the dog leash can be fastened around the urethane cord, and the shackle (or other fastener) end attached to the dog. In an emergency, the user can pull the pin, thereby releasing the dog quickly, without unfastening the belt.

In another preferred embodiment, the leash can be a tactical leash for dog training. In this embodiment, the handle preferably has a grip, a temporary quick tether, and a swivel connector. The grip is preferably sturdy and stiff but still resilient, such as a luggage or utility handle. The temporary quick tether may be a flat or side buckle or hook and loop fastener, and the swivel connector may be the previously described type using a male/male swivel fitting. The swivel connector may be secured to the handle in any suitable fashion.

The tactical leash has a shock absorbing extension of variable lengths depending on the relative sizes of the user and animal, but typically about 6 inches long and having interchangeable swivel connectors at each end. The extension may be inserted between the handle and the wrist guard. The shock absorbing extension may be made of the same or different materials as the body, but is preferably of similar appearance for the sake of aesthetics.

The wrist guard for the tactical leash preferably is made of material similar to the wrist guard of the medical leash, and has a graspable feature, such as a loop, for easy grip and increased control of one or more animals. The length of the wrist guard for the tactical leash is the same as for the medical leash.

A tactical leash will typically have a body and chew guard similar to a medical leash. In some cases, the body may preferably be made of metal, such as a chain. This would be especially true where an animal has a tendency to chew hard on the leash. Where chain is used, it may also have a plastic or fabric sleeve to reduce tangling and for aesthetic purposes.

Yet another preferred embodiment of the present invention is a multiple-dog leash. The multiple-dog leash may be configured simply by opening the handle of either of the present embodiments, and adding other types of leashes at will. Preferably, the leash has a multiple-dog coupler or splitter, which has a swivel connector at its first end and at each of the two or more opposite or terminal ends. The first end of the coupler is preferably attached to a wrist guard, an extension, or a body segment of the leash. The multiple-dog coupler is preferably made of any of the materials used for the wrist guard and chew guard, but may also be made of the same materials as the body, depending upon the desires of the customer.

Where a leash has a multiple coupler, it has multiple body segments, preferably of identical length. In preferred embodiments, the multiple coupler has two or three segments, each terminating in a swivel connector. Successive multiple couplers can be alternated with body segments of the same or different lengths to produce a single leash system for any number of animals. The multiple coupler is typically a single folded and stiched, or two or three or more strips of polypropylene webbing 4 to 12 inches long, and preferably about eight inches long. In certain embodiments, a shorter length multiple coupler, about 4 inches or less, is preferred. The would be the case where reduced weight and even further control of potential tangling is desired.

In another embodiment, a coiled extender accessory may be used. This accessory has a swivel connector at each end, and can be stretched under light pressure. Suitable coiled materials are commercially available, or may be manufactured, for example using the polyurethane tubing that is preferred for the body of the present invention. The tubing can be wrapped around a metal rod, vulcanized, and then inverted, to produce a tightly coiled, stretchable extender. The coiled extender accessory may preferably be attached between the wrist guard and the body, but more preferably is located between the handle and the wrist guard. This can allow the animal greater freedom of movement in a relaxed setting. In the event that greater control of the animal is required, the handle can be opened and attached easily to a wrist guard having a loop or other graspable feature.

In yet another embodiment, an adaptor accessory or multifastener configured like, and made of materials similar to, a chew guard, can be used as an alternative to a handle, which is especially useful for hands-free use. Like the chew guard, the multifastener has a first swivel connector that is adapted to connect to the body, extension, or wrist guard of the leash, and a second connector, which may be a swivel connector, but is preferably shackle, clip, or Velcro™ hook and loop closure. The second connector fastens to any anchor point, such as a belt loop, polyurethane cord, utility tool belt, D-loop or metal ring. In this case, the length of the adaptor is more variable than that of a chew guard, and may be much shorter, preferably about 3 to 18 inches in length and typically about 6 inches. Where a user prefers to use the leash with a specific or custom handle apparatus, the adaptor can be used to attach the body of the leash to the customer's handle.

In other embodiments, features may be added to the handle, an extension, or the wrist guard. For example, the handle may conveniently incorporate a light, preferably an LED flash light or lights may be attached or incorporated into any portion of the leash. A pocket or connector may be added to the handle, extension, or wrist guard or body to accommodate waste bags. Reflective, decorative, or ornamental materials may be added to any portion of the leash. One of ordinary skill in the art will readily recognize that equivalents of the materials and parts disclosed herein may be substituted in a dog leash, and still be within the spirit and scope of the invention.

What is claimed is:

1. A leash comprising a handle comprising a grip and a temporary quick tether, operably connected to a wrist guard, said wrist guard also operably connected to a body, said body also operably connected to a chew guard having a terminal end comprising an attachment selected from the group comprising swivel connectors, shackles, clips, or hook and loop closures.

2. The leash of claim 1, wherein the grip is selected from the group comprising flexible padded fabric, rubber, thermoplastic and leather, and the temporary quick tether is independently selected from the group comprising hook and loop closures, side release buckles or flat buckles.

3. The leash of claim 1, wherein the wrist guard comprises at least one strap made of polypropylene, nylon, polyester, polyurethane or leather.

4. The leash of claim 3, wherein the wrist guard furthers comprises a graspable feature.

5. The leash of claim 1, wherein the body is selected from leather, rope, chain, or urethane cord.

6. The leash of claim 1, wherein the chew guard is nylon, polyester polypropylene or polyurethane web 10 to 18 inches in length.

7. The leash of claim 1, further comprising an extender, operably connected between the handle and the wrist guard.

8. The leash of claim 1, further comprising at least one multiple coupler and a suitable number of body segments.

9. The leash of claim 1, wherein the handle, wrist guard, body and chew guard are operably connected by means of swivel connectors.

10. The leash of claim 9, where one or more of the swivel connectors is configured as a safety release.

11. A method of making an animal leash, the steps comprising selecting from a group of modular components operably connectable by interchangeable swivel fasteners, the components comprising
a handle comprising a grip selected from the group comprising flexible padded fabric, rubber, thermoplastic and leather, and a temporary quick tether independently selected from the group comprising hook and loop closures, side release buckles or flat buckles,
a wrist guard comprising at least one strap made of polypropylene, nylon, polyester, polyurethane or leather
a body selected from leather, rope, chain, or urethane cord a chew guard selected from nylon, polyester polypropylene or polyurethane web 10 to 18 inches in length having a terminal end comprising an attachment selected from the group comprising swivel connectors, shackles, clips, or hook and loop closures,
and connecting said modular components by means of said swivel fasteners in an arrangement and order desired by a customer.
